(19) United States
(12) Patent Application Publication
(10) Pub. No.: US 2024/0270012 A1
(43) Pub. Date: Aug. 15, 2024

(54) ULTRA-LIGHTWEIGHT STEEL WHEEL FOR COMMERCIAL VEHICLE

(71) Applicants: Thyssenkrupp Steel (Beijing) Co., Ltd., Beijing (CN); Thyssenkrupp Steel Europe AG, Duisburg (DE)

(72) Inventors: David PIERONEK, Beijing (CN); Wei TIAN, Beijing (CN)

(73) Assignees: Thyssenkrupp Steel (Beijing) Co., Ltd., Beijing (CN); Thyssenkrupp Steel Europe AG, Duisburg (DE)

(21) Appl. No.: 18/565,734

(22) PCT Filed: Jun. 9, 2022
(86) PCT No.: PCT/CN2022/097843

§ 371 Date: Nov. 30, 2023

(30) Foreign Application Priority Data
Jun. 10, 2021 (CN) 202110648441.2

(51) Int. Cl. B60B 3/00; B60B 3/04; B60B 21/02; C21D 9/34

(52) U.S. Cl. CPC B60B 3/001; B60B 3/044; B60B 21/023; B60B 2310/302; B60B 2360/102; B60B 2900/111; B60B 2900/112; C21D 9/34; C21D 2211/008

(57) ABSTRACT

The present application relates to an ultra-lightweight steel wheel for a commercial vehicle. The wheel has excellent material characteristics and an advanced design, and consists of a rim for mounting a tire, and a disc having a hub flange for detachably connecting to a wheel hub or axle, wherein the rim and/or disc is made of a heat-treated and hardened steel material with a carbon content between 0.18 wt % and 0.37 wt %, and the disc and/or rim principally consists of a martensitic microstructure and has a tensile strength of at least 900 MPa. The maximum thickness of the rim is less than 4.50 mm and/or the maximum thickness of the disc is less than 12.00 mm, wherein the value of the product of the wheel diameter and the wheel width divided by the wheel mass is greater than 4000 mm²/kg.

### TECHNICAL FIELD

The present application relates to an ultra-lightweight steel wheel for a commercial vehicle, which wheel has excellent material characteristics and an advanced design. The wheel is formed of a rim for mounting a tire, and a disc having a hub flange for detachably connecting to a wheel hub or axle, wherein the rim and/or disc is made of a heat-treated and hardened steel material with a carbon content of 0.18 wt % to 0.37 wt %, and the disc and/or rim principally consists of a martensitic microstructure and has a tensile strength of at least 900 MPa.

### BACKGROUND ART

Standard steel wheels for commercial vehicles (CV) such as trucks, buses and trailers are formed of a one-piece wheel disc and a one-piece wheel rim, which are fixed together permanently. The wheel rim forms a peripheral part of the wheel, and is thus used to hold a tire with or without an inner tube. The wheel disc has a hub flange for detachably connecting to a wheel hub of a vehicle. For the past few decades, cold forming processes have been used to make wheel discs and rims in batches from flat steel material. The steel material generally used is non-alloy steel, structural steel or microalloyed fine-grained structural steel with a carbon content lower than 0.18 wt % and/or a tensile strength (Rₘ) lower than 700 MPa (e.g. HR 420/S420 MC). The main requirement for commercial vehicle wheels is that they have maximum fatigue life, safety and strength with minimum weight and cost.

Measures to reduce the weight of commercial vehicles have a direct impact on total fuel/energy consumption, sustainability and payload increase, and due to the fact that the wheels are also rotating, their quality is an important influencing factor. In addition, due to steadily rising CO₂ emissions as well as strict regulations, OEMs are currently searching for sustainable and cost-effective weight reduction solutions for components of goods vehicles and cars.

A known method of reducing wheel weight is to reduce the thickness of components locally; the overall performance remains unaffected and can still meet requirements. For example, the thickness of the hub flange of the disc is about twice that of a conical wheel disc region or an outer flange for joining to the rim. Local and gradual thickness reduction may be achieved by spinning/spin forming of the disc and/or rim; these are real examples disclosed in the international patent applications WO 2015/159231 A1 (for discs) and WO 2018/051282 A1 (for rims).

Another method of achieving weight reduction is to use a steel material with higher strength, e.g. as disclosed in the patent CN 103909381 B1. Generally, high-strength steel is accompanied by a drop in formability and processing characteristics, making it difficult to fully tap the potential of weight reduction. In addition, higher material strength will not automatically be associated with higher fatigue performance and safety, and this is a key factor in enabling innovative steel wheels to have their weight reduced further.

The problem to be solved by the present application is to provide an ultra-lightweight and cost-effective steel wheel for a commercial vehicle; compared with known prior art, the steel wheel can be designed with optimal fatigue performance, safety and weight.

### SUMMARY OF THE INVENTION

According to the present application, the above-mentioned problem can be solved due to the following features, wherein the maximum thickness of the rim is less than or equal to 4.50 mm and/or the maximum thickness of the disc is less than or equal to 12.00 mm, wherein the value of the product of the wheel diameter and the wheel width divided by the wheel mass is greater than 4000 mm²/kg, preferably greater than 4400 mm²/kg, and in particular greater than 4600 mm²/kg.

Through comprehensive research based on fatigue testing of special bending test samples of different steel types, the inventors surprisingly discovered that a steel material principally consisting of a martensitic microstructure and having a specific chemical composition exhibited significantly improved fatigue performance under cyclic bending loads, and this is particularly beneficial for wheel applications. The objective of a specific alternative test (sample strip) was to reproduce the non-uniform stress state of a wheel during bending fatigue testing. During fatigue testing, one end of a specific sample was clamped in a measurement apparatus, and the opposite free end was exposed to a sinusoidal load (alternating load). A relevant alternative testing method for wheels is disclosed in the patent EP 3 115 767 B1.

Based on the test results, Table 1 shows exemplary extracts, and an advantageous steel material was determined, whose average cyclic bending fatigue strength was at least three times higher than that of standard steel (e.g. HR 420) used for commercial vehicle wheels. In addition, compared with advantageous steel material A, the fatigue performance of heat-treated and hardened steel materials B and C was significantly reduced, thus also proving that an increase in material strength and/or carbon content will not automatically lead directly to better fatigue behaviour. Furthermore, additional properties of heat-treated and hardened steel materials can be improved through specific surface treatment.

TABLE 1

| Material | C | Si | Mn | Cr | Mo | Bending fatigue | |
|---|---|---|---|---|---|---|---|
| HR 420 | 0.11 | 0.1 | 1.52 | — | — | 440 | MPa |
| Steel A | 0.22 | 0.21 | 1.22 | 0.08 | — | 1470 | MPa |
| Steel B | 0.38 | 0.39 | 0.78 | 0.92 | 0.24 | 950 | MPa |
| Steel C | 0.45 | 0.41 | 0.62 | 0.31 | 0.08 | 900 | MPa |

The second part of the present application relates to using determined material characteristics and measured advantageous stress conditions, to develop and make novel designs of lightweight steel wheels of diameter 420 mm-600 mm and width 175 mm-300 mm. It can be determined through deeper simulation-based research work and subsequent prototype tests that if the value of the product of the wheel diameter and the wheel width divided by the wheel mass is greater than 4000 mm²/kg, preferably greater than 4400 mm²/kg, and in particular greater than 4600 mm²/kg, the performance of the steel wheel according to the present application is especially advantageous. In addition, the value of the product of the maximum thickness of the rim and the maximum thickness of the disc does not exceed 56 mm², and preferably does not exceed 50 mm². In particular, the maximum thickness of the rim should be less than or equal to 4.50 mm, and/or the maximum thickness of the disc should be less than or equal to 12.00 mm. Thus, the weight of the developed wheel can be significantly reduced and its rotational inertia can be lowered, while fatigue strength and safety requirements remain feasible.

According to the standards defined in (for example) ETRTO, T&RA and DIN, the wheel width and diameter are measured in the region from tire bead seat to tire bead seat. The total mass of the steel wheel is measured as the wheel mass; the tire is not taken into account. The maximum thickness of the disc is generally located at the hub flange, i.e. the region where the wheel is fastened (by bolts) to the hub or axle, and the minimum disc thickness is generally in a conical region and/or a region of contact with the rim. In general, the maximum thickness of the rim is obtained at the rim groove of a grooved rim and/or a joint region and/or a rim edge which is in direct contact with the tire and thus needs to sustain high local stress concentration.

In order to suitably balance the stress distribution of the disclosed lightweight steel wheel, and thereby reduce weight to the maximum extent, it is very important that the designated value of the maximum thickness combination of the rim and the disc is 56 mm², preferably 50 mm². A sensible value for the maximum thickness combination should exceed 15 mm², preferably 20 mm². It has already been found that the potential of weight reduction cannot be fully tapped when the value of the maximum thickness combination is greater than 56 mm², and in some applications and designs, this even results in poor performance. This is due to failure to suitably balance the rigidity and deformation behaviour of the wheel located between the hub and tire, so that high local stress concentration is introduced in the steel wheel, resulting in overloading and early failure. By limiting the maximum rim thickness to at most 4.50 mm and the maximum disc thickness to at most 12.00 mm, the optimum performance result is achieved. Thus, according to the new discovery of the present application, the maximum thickness proportions of the rim and the disc should be limited to the disclosed range and meet standards.

In addition, the rim thickness should not be less than a minimum thickness of 1.5 mm at any position, is preferably not less than 2.0 mm, and in particular not less than 2.5 mm, so as to ensure that the rim part has sufficient local rigidity and strength. In addition, the minimum thickness of the disc should not be less than 6.00 mm and is preferably not less than 7.50 mm in the region of the hub flange, and in the conical region, is not less than 2.0 mm, preferably not less than 2.5 mm and in particular not less than 3.0 mm, so as to avoid undesired stress localization in the disc and thereby prevent early crack initiation and failure of the whole component.

In order to further optimize stress distribution in the joint region of the disc and rim, it was found that when the value of the product of the maximum rim thickness in the conical region and/or the contact region and the minimum disc thickness does not exceed 30 mm², the local stress level can be reduced and homogenized. Otherwise, the rigidity of the joint will be too high, leading to the onset of high stress concentration in the vicinity of the contact region, which might result in early failure of the martensitic microstructure which is dominant in the final component (the disc and/or the rim), thereby lowering the overall performance of the disclosed wheel. A sensible value of the product of the maximum thickness of the rim and the minimum thickness of the disc in the contact region should exceed 7 mm².

According to another embodiment of the commercial vehicle steel wheel of the present application, the disc and the rim are press-fitted, and are additionally fixed by welding, brazing, bonding or another joining technique. Press-fitting results in a doubling of material in the contact region and overlap of the rim and the disc. The total thickness of the lap joint in the contact region should be less than 11.0 mm, preferably less than 9.5 mm, so as to ensure that stress is advantageously transmitted into the different components. It has already been found that when the total thickness of the lap joint is greater than 11.0 mm, the inappropriate transition in rigidity mainly causes early failure in the vicinity of the weld region, and thus results in complete failure of the entire wheel. On the other hand, the total thickness should exceed 5 mm, so as to ensure that the joint has appropriate fatigue and rigidity performance.

During assembly, thermal joining techniques will introduce additional heat in the final component (disc/rim), and can affect/alter the material characteristics of heat-treated and hardened steel which consists principally of a martensitic microstructure. According to the disclosed design criteria, a thermal effect region with a local hardness lower than 350 HV 0.1 and a radius of 25 mm is acceptable around a weld region of the contact region, on the condition that press-fitting and an additional joining technique are used. In addition, if the wheel disc has an inspection hole, the hardness in the vicinity of its edge is not less than 350 HV 0.1, so an additional performance improvement can be achieved.

According to another embodiment of the commercial vehicle steel wheel of the present application, the heat-treated and hardened steel is boron steel or manganese boron steel, and the microstructure of the heat-treated and hardened steel in the disc and/or the rim consists principally of martensite; preferably more than 80% and in particular more than 90% of the microstructure consists of martensite. Heat-treatable steel such as 17MnB3, 20MnB5, 22MnB5, 30MnB5 or 34MnB5 is suitable for a hardening process, and is used as a workpiece in the manufacture of the rim and/or the disc, exhibiting the required performance and optimum performance during bending fatigue testing of a steel sample and subsequent wheel prototype testing. Compared with the concept of conventionally used steel, the above-mentioned steel has higher cyclic bending fatigue strength, which in particular can extend the service life of the corresponding component, and can prevent premature material failure to a very large extent.

According to another embodiment of the commercial vehicle steel wheel of the present application, an indirect hot stamping or pressure hardening process is used to manufacture the heat-treated and hardened steel material consisting principally of a martensitic microstructure in the final component (disc and/or rim).

According to another embodiment of the commercial vehicle steel wheel of the present application, the average surface roughness Ra of the heat-treated and hardened disc and/or rim is between 0.8 μm and 1.8 μm. In particular, the surface of the heat-treated and hardened disc and/or rim is subjected to mechanical processing, for example, by shot peening or shot-peening hardening, thereby improving the surface quality of the final component (disc and/or rim) consisting principally of a martensitic microstructure.

According to an embodiment of the commercial vehicle steel wheel of the present application, the rim and disc are made of heat-treated and hardened steel, wherein the rim and disc consist principally of a martensitic microstructure, and have a tensile strength of at least 900 MPa. In addition, the average tensile strength and/or hardness of the hub flange region of the disc are/is less than the average tensile strength and/or hardness of the conical region and/or contact region of the disc.

According to an optional embodiment of the commercial vehicle steel wheel of the present application, the rim is made of heat-treated and hardened steel consisting principally of a martensitic microstructure, and has a tensile strength of at least 900 MPa; the disc is made of a different steel material, which is a cold-formed steel material and has not undergone heat treatment and hardening. The disc is made of a steel material with a carbon content lower than 0.22 wt %, in particular lower than 0.20 wt % and preferably lower than 0.18 wt %, in particular a microalloyed fine-grained structural steel such as HR 420, HQ 420, S420MC, S460MC, HR 500, HR 550, HQ 600 MC, HR 700, HR 760 or higher grade. Alternatively, structural steel may also be used, such as S235, S275 or S355; non-alloy steel may also be used, such as DD11; and multi-phase steel may also be used, such as ferrite-bainite dual-phase steel or bainite steel. In the microstructure of the steel material of the disc as the final component and the cold-formed disc, the martensite content is less than 40%, in particular less than 20% and preferably less than 5% (including 0%). In particular, more precisely, the tensile strength of the hub flange is lower than 900 MPa. The thickness is reduced by spinning, so the material strength of the conical region of the final disc is generally increased relative to the hub flange.

### BRIEF DESCRIPTION OF THE DRAWINGS

The present application is described in more detail below with the aid of the drawings, which describe sample embodiments. In the drawings, identical components have identical reference labels.

FIG. 1 shows a sample embodiment including a schematic sectional view of a commercial vehicle steel wheel according to the present application.

FIG. 2 shows a micrograph through a joint and contact region between a rim and disc.

### DETAILED DESCRIPTION OF THE INVENTION

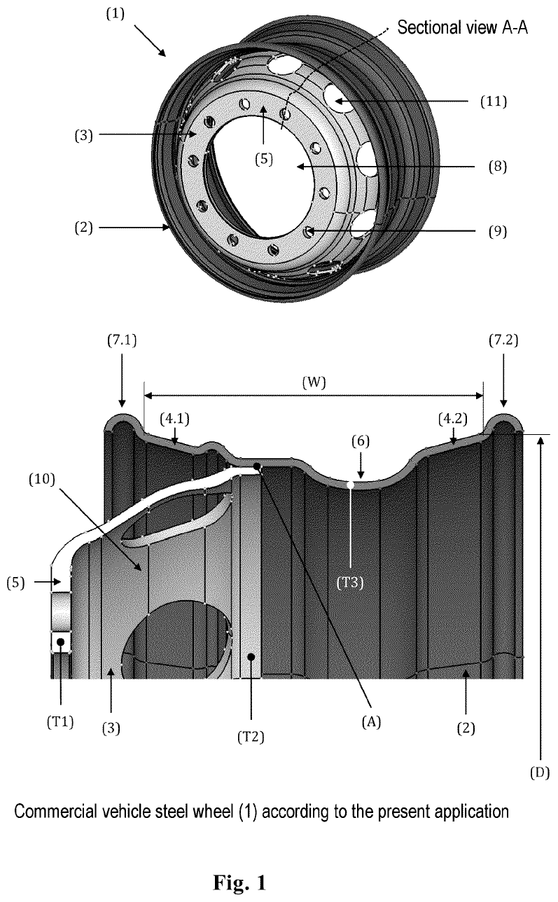

FIG. 1 shows a sectional view through a sample embodiment of a commercial vehicle steel wheel (1) according to the present application. The commercial vehicle wheel (1) comprises: a grooved rim (2) with a (for example) 15° tire bead seat, for holding a tubeless tire (the tire is not shown); and a disc (3) connected to the rim (2). The commercial vehicle wheel shown has a diameter (D) of 572 mm and a width (W) of 229 mm, and is designed as a truck wheel with dimensions of 22.5×9.00 and a maximum wheel load of 4000 kg.

The disc (3) is bowl shaped, principally comprising a planar hub flange region (5) and a conical region (10); the hub flange region (5) has a central hole (8) and bolt holes (9) for detachably connecting to a hub, the conical region (10) has ventilation holes or inspection holes (11), and the conical region ends at a joint region (A) of an outer diameter and the rim (2). The disc (3) is formed as a single piece by spinning, and has different thicknesses, with a maximum thickness (T1) located in the hub flange region (5) and reaching 11.0 mm.

The thickness of the conical region (10) varies radially, with a minimum thickness of 4.0 mm (T2). The disc (3) is formed of manganese boron steel, in particular 30MnB5. After spinning and after-treatment operations (e.g. cutting), the disc (3) undergoes heat treatment and hardening, to achieve dominance of a martensitic microstructure in the final component. After heat treatment and hardening, the strength of the disc (3) is greater than 1400 MPa (Rm), in particular in the conical region.

The rim (2) is annular, with an overall thickness (T3) reaching 3.7 mm; the maximum rim thickness is also 3.7 mm. The rim is also formed of manganese boron steel, in particular 20MnB5. After forming the annular shape and shaping, the rim also undergoes heat treatment and hardening, to achieve a completely martensitic microstructure in the final component. After heat treatment, the material strength of the rim (2) is greater than 1200 MPa (Rm).

The disc (3) and the rim (2) are joined by press-fitting and laser welding. The total thickness (O) of the lap joint is 7.7 mm, so is less than the maximum permitted thickness of 11.0 mm. Based on the design thicknesses of all components, all defined thickness proportions are satisfied. The product of the maximum rim thickness (T3) and the minimum disc thickness (T2) reaches 14.8 mm², which is less than the specified value of 30 mm². The product of thicknesses (T1) and (T3) is equal to 40.7 mm², which is less than the specified value of 56 mm², and in particular is less than the specified value of 50 mm². The total wheel mass is about 26 kg, so the key performance factor of the designed wheel is 5038 mm²/kg, which is obviously greater than the required 4000 mm²/kg.

In comparison, the weight of a commercial vehicle steel wheel in the prior art, in a comparable state and with the same dimensions and wheel load, is about 36 kg. The maximum rim thickness is greater than 4.50 mm, and the maximum thickness of the disc in the hub flange is generally greater than 12.0 mm. Thus, a standard wheel cannot meet all of the requirements of the disclosed wheel.

To reduce weight further, it is also possible to apply a spinning process to the rim (2) rather than to the disc (3) alone, and optimize the thickness distribution along the rim width before the heat treatment and hardening process.

According to another solution of the embodiments, the rim (2) is made of manganese boron steel, in particular 22MnB5, and the disc (3) is made of a steel material with a carbon content lower than 0.18 wt %; this steel material undergoes cold forming, but does not undergo heat treatment and hardening, and in particular is a microalloyed fine-grained structural steel, specifically S 550 MC, for example. The rim thickness (T3) reaches 3.50 mm, the maximum thickness (T1) of the disc (3) in the hub flange (5) reaches 12 mm, and the minimum thickness (T2) of the disc (3) in the conical region (10) reaches 6.00 mm. The rim (2) alone undergoes additional heat treatment and hardening and has a microstructure in which martensite is dominant, preferably having at least 90% martensite, and the strength of the final component is greater than 1400 MPa (Rm). Conversely, the microstructure of the disc (3) does not change, and the material strength is equal to about 700 MPa (Rm), in particular, mainly in the hub flange region (5). The content of martensite in the microstructure of the disc (3) is less than 20% (including 0%).

The width (W) of the wheel (1) is measured radially from an inside tire bead seat region to an outside tire bead seat region, and the diameter (D) is measured radially from one tire bead seat region to another tire bead seat region, as shown in FIG. 1.

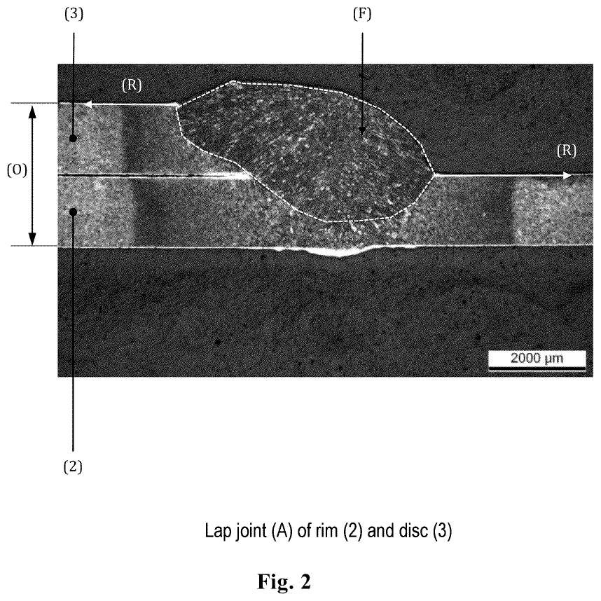

FIG. 2 shows a micrograph through a joint and contact region (A) between the rim (2) and disc (3). In this embodiment, the disc (3) and the rim (2) are joined by press-fitting and additional arc welding (F). The thermal joining of the disc (3) and the rim (2) is not limited to arc welding; laser welding, CMT welding, laser hybrid welding and brazing may also be used, but a controllable joining technique with a low heat input is preferred. Thus, adhesive bonding may also be used to make the stress distribution uniform, and avoid the input of more heat into the wheel components.

### KEY TO THE DRAWINGS

1 commercial vehicle steel wheel
2 rim
3 disc
4.1 tire bead seat (outer) of rim
4.2 tire bead seat (inner) of rim
5 wheel hub flange (connection region) of disc
6 rim groove of (deep-grooved) rim (with (for example) 15-degree tire bead seat)
7.1 rim flange/edge (outer)
7.2 rim flange/edge (inner)
8 central hole of disc
9 bolt holes of hub flange
10 conical region of disc
11 ventilation holes/inspection holes
D wheel diameter/rim diameter [mm]
W wheel width/rim width [mm]
A contact region of lap joint between disc and rim [mm]
R weld region radius (involves range of disc and/or rim)
O total thickness of lap joint of contact region
F weld region caused by thermal joining
T1 (maximum) thickness of disc (in hub flange region) [mm]
T2 (minimum) thickness of disc (in conical or contact region) [mm]
T3 (maximum) thickness of rim (at rim groove) [mm]

1. A commercial vehicle steel wheel, having a rim for mounting a tire, and a disc having a hub flange for detachably connecting to a wheel hub, wherein at least one of the rim and disc is made of a heat-treated and hardened steel material with a carbon content between 0.18 wt % and 0.37 wt %, and at least one of the disc and rim principally consists of a martensitic microstructure and has a tensile strength of at least 900 MPa, wherein at least one of characterized in that the maximum thickness (T3) of the rim is less than or equal to 4.50 mm and the maximum thickness (T1) of the disc is less than or equal to 12.00 mm, wherein a value of a product of a wheel diameter (D) and a wheel width (W) divided by a wheel mass is greater than 4000 mm²/kg.

2. The commercial vehicle steel wheel as claimed in claim 1, wherein a product of a maximum thickness (T3) of the rim and the maximum thickness (T1) of the disc is less than 56 mm².

3. The commercial vehicle steel wheel as claimed in claim 2, wherein a product of the maximum thickness (T3) of the rim and the minimum thickness (T2) of the disc is less than 30 mm².

4. The commercial vehicle steel wheel as claimed in claim 3 wherein the disc and the rim are press-fitted, and are additionally fixed permanently by at least one of welding, adhesive bonding and brazing, wherein a total thickness (O) of a contact region (A) of a press-fitted joint of all wheel components is less than 11.0 mm.

5. The commercial vehicle steel wheel as claimed in claim 4 wherein an additional heated region with a radius (R) of 25 mm is exhibited around a weld region (F) of at least one of the disc and the rim, and a hardness value of at least one of the disc and the rim falls to lower than 350 HV 0.1 in the additional heated region.

6. The commercial vehicle steel wheel as claimed in claim 5 wherein at least one of the wheel diameter (D) is greater than or equal to 420 mm and the wheel width (W) is greater than or equal to 175 mm.

7. The commercial vehicle steel wheel as claimed in
claim 6 wherein the value of the product of the wheel diameter (D) and the wheel width (W) divided by the wheel mass is greater than 4600 mm²/kg.

8. The commercial vehicle steel wheel as claimed in claim 6 wherein the wheel diameter (D) is between 560 mm and 600 mm.

9. The commercial vehicle steel wheel as claimed in
claim 6 wherein the wheel width (W) is between 200 mm and 300 mm.

10. The commercial vehicle steel wheel as claimed in
claim 6 wherein an average surface roughness (Ra) of at least one of (i) the heat-treated and hardened disc and (ii) rim is between 0.8 μm and 1.8 μm.

11. The commercial vehicle steel wheel as claimed in claim 6 wherein one of a spinning and spin forming process is used to form the disc and rim having different thicknesses.

12. The commercial vehicle steel wheel as claimed in
claim 6 wherein the disc has a ventilation hole or an inspection hole, such that a hardness in a vicinity of an edge of the inspection hole will not fall to a hardness value lower than 350 HV 0.1.

13. The commercial vehicle steel wheel as claimed in claim 6 wherein the rim is made of heat-treated and hardened steel consisting principally of a martensitic microstructure, and has a tensile strength of at least 900 MPa, wherein the disc is made of a different steel material, which is a cold-formed steel material and has not undergone heat treatment and hardening.

14. The commercial vehicle steel wheel as claimed in claim 6 wherein the rim and the disc are both made of heat-treated and hardened steel, and the rim and disc principally consist of a martensitic microstructure and have a tensile strength of at least 900 MPa.
